(19) United States
(12) Patent Application Publication
(10) Pub. No.: US 2003/0216672 A1
(43) Pub. Date: Nov. 20, 2003

(54) System and method for healing skin injuries

(75) Inventors: Jahangir S. Rastegar, Stony Brook, NY (US); Harry Soroff, Northport, NY (US)

Correspondence Address: Paul J. Esatto, Jr., Scully, Scott, Murphy & Presser, 400 Garden City Plaza, Garden City, NY, 11530, US

(73) Assignee: The Research Foundation of State University of New York, Albany, NY (US)

(21) Appl. No.: 10/146,679

(22) Filed: May 15, 2002

(51) Int. Cl. A61H 9/00

(52) U.S. Cl. 601/9; 601/11; 601/152

(57) ABSTRACT

A method for facilitating the healing of damaged skin of a patient. The method including: isolating the damaged skin in an enclosure having an air-tight seal between a portion of the enclosure and adjacent skin, the enclosure and skin forming a chamber; and applying cycles of positive and negative pressure in the chamber to enhance blood flow to outer layers of the damaged skin and inhibit the formation of edema in the damaged skin. Preferably, the method further includes: detecting a cardiac cycle of the patient; and wherein the applying comprises synchronizing the application of the positive and negative pressure in the chamber to the detected cardiac cycle.

### BACKGROUND OF THE INVENTION

1. Field of the Invention

The present invention relates generally to systems and methods for healing skin injuries, and more particularly, to healing skin injuries caused by burns, frostbite, or from a prolonged exposure to abnormal pressure.

2. Prior Art

The application of constant pressure over a period of several hours to an area of the skin can cause necrosis. This complication may be experienced by patients who are anaesthetized, and lying in one position without moving or who are elderly and bedridden and who lie on their back or side in such a way that pressure is applied to the skin overlying a bony prominence such as the sacrum, the femoral trochanter, or heel of the foot. When this occurs, the skin becomes necrotic, and a decubitus ulcer develops. The care of such patients is extremely prolonged and costly, and may eventually result in their death from chronic infection.

In burned patients who sustain a deep dermal injury, the following sequence of events can ensue. When the patient is first admitted to the hospital, the affected areas appear to be of a partial thickness nature, and would be expected to heal with conservative therapy. However, with the passage of up to 12-24 hours, it often becomes apparent that the injury has progressed to involve the full-thickness of the skin and that it will require excision and grafting.

In the past, it has often been proposed that the injury to the skin has “converted” from a partial to full-thickness injury due to bacterial overgrowth of the injured area.

### SUMMARY OF THE INVENTION

The following mechanism, however, is considered to be the major cause of the aforementioned “conversion” to full-thickness injury. The nutrition of the skin is via blood flowing in the vessels that arise in the muscle and pass outward to the subcutaneous tissues, where they are of a fairly large caliber. As the vessels enter the dermis and then proceed peripherally to the outer layer of the dermis, they divide into smaller and smaller branches. An analogy would be that of a tree. The larger vessels are like the trunk of the tree, and then they progress to branches of decreasing caliber, finally reaching the periphery where they become very fine channels that can be easily occluded by increased pressure applied external to their walls by edema fluid.

In patients with large bums who receive approximately 4 cc of fluid per Kg by weight per % bum, the edema of the burned areas contributes to the progressive injury of the skin by compressing the vessels supplying blood to the skin. For example, a patient who weighs 70 Kg and sustains a 50% (%) body surface bum receives at least 4.0 cc×70 Kg×50 (%) i.e., 14000 cc of I.V. fluid in the first 24 hours after injury. The burned area invariably swells, because the capillaries that are injured by the heat of the bum, allow plasma to escape into the tissue. With time, in patients who recover, usually after about 5-7 days, the tissue fluid is reabsorbed from the burned tissue and is excreted via the urinary tract. But in the case of the injured skin, the damage to the burned area progresses and cannot be reversed. In a very large bum, the need for extensive surgery may in itself be life threatening, especially if the patient is elderly and suffers from other chronic illnesses, or is an infant.

Thermal injury occurs when the tissues are heated above a temperature of 40-44° C. for a sustained period. The relationship between the temperature and the time of exposure is well known in the art. As the temperature is sustained above 40° to 44° C. the enzyme systems of the cells begin to malfunction and denaturation of protein occurs. Those in the art have stated that tissues such as skin in which water is the major component have a high specific heat and a low thermal conductivity. This explains the observation that skin overheats slowly, and conversely cools slowly. The duration of the overheating of skin endures considerable longer than the presence of the agent producing the burn. As a result, the applied heat continues to penetrate the depth of the tissues, and provides an explanation for the profound physiologic alterations caused by a burn in which tissues remote from the site of the burn develop edema.

The burn wound can be thought of as an area of injury that is three-dimensional. The cells that are in direct contact with the intense heat go on to die. This area is called the “zone of coagulation”, and contains the destroyed skin or “eschar”. Directly surrounding the area of coagulation is a zone of lesser injury called the “zone of stasis”, thus extending the severity of the loss of tissue secondary to the burn. It has been demonstrated that the Po₂ levels are consistently at hypoxic levels at the edge of the edematous tissues, as well as at the center of the burned tissue. The impairment of blood flow is also aggravated by the formation of microthorombi secondary to platelet aggregation, neutrophil adherence to vessel walls, fibrin deposition, endothelial swelling and venous vasocontstriction. An additional factor which impair the delivery of oxygen to the tissues is that the erythrocytes that have been exposed to the heat, lose their ability to deform as they progress through the microcirculation.

Surrounding the “zone of stasis” is an area in which the circulation is actually increased. This area is termed the “zone of hyperemia”.

The amount of edema which develops in the burned area and in the adjacent soft tissues, is a major determinant of the fate of the much large volume of tissues surrounding the “zone of coagulation”; and influences whether the capillary stasis reverses itself, or goes on to necrosis. The new treatment attempts to control the formation of edema by the application of synchronous external pulsatile pressure thus restoring normal perfusion of the skin.

The various factors which control the production of burn wound edema will now be considered.

Burn wound edema develops when the rate at which fluid is filtered from the vessels into the tissues exceed the rate by which fluid leaves the tissues and enters into the lymph channels (J_{L}) which drain that area. Following a burn, the rate of formation of edema increases immediately. It has been observed experimentally, that there is a 70-80% increase in the water content (i.e. edema) of a full thickness burn by 30 minutes post burn. The rate of edema formation then continues, but more gradually, both into the burned and the surrounding unburned tissue for the following 24 hours. The amount of edema that is formed is proportional to the extent of the burn and its depth. The depth is dependent upon the burning agent, and for how long it is in contact with the skin, i.e., water, oil, gasoline, or the vapors of an explosive agent. The edema formation is also influenced by the administration of resuscitation fluid. The amount of fluid usually administered immediately post burn to correct hypovolemia and maintain normal parfusion of vital organs is Lactated Ringers Solution in the amount of 4^{cc}/kg/% burn. However, the large amount of fluid that is given, also serves to augment the edema.

The physical forces that govern the movement of tissue fluids between the vascular and extra-vascular compartments are described by the Landis-Starling equation: Jv=K_{f}[(P_{c}−P_{if})−O (πₚ−π_{if})]. Edema occurs when the lymphatic drainage (J_{L}) does not keep pace with the increase in Jᵥ, the volume of fluid that crosses the microvasculature barrier; Kᵣ is the capillary filtration coefficient, which is the product of the capillary surface area and the hydraulic conductivity; P_{c} is the capillary hydrostatic pressure; P_{if} is the interstitial hydrostatic pressure; O is the osmotic reflection coefficient; πₚ is the interstitial fluid hydrostatic pressure of plasma, and π_{if} is the correct osmotic pressure of interstitial fluid.

Edema will occur if K_{f}, P_{c}, or π_{if} are increased; or if O, P_{if}, or πₚ are decreased. In a severe burn, all of the above variables change significantly in the direction that results in increased fluid filtration, Jᵥ, and edema formation.

Capillary Filtration Coefficient (Kᵣ)

Immediately after the bum, there is a two-to-three-fold increase in the capillary filtration coefficient (K_{f}), indicating that there is an increase in the water permeability or/in the hydraulic conductivity of the capillary wall. But since K_{f} is also a function of the capillary surface area, local vasodilatation may also contribute to the increased K_{f}, since the over-all size of the capillary bed is increased. Another contributing factor may be that the heat created during the burn damages the capillary and venular/endothelial cells, and causes them to swell. This swelling disrupts the intercellular connections and creates avenues for fluid loss. The release from the injured tissue of brady kinins, and oxygen free radicals probably also contributes to the increased capillary permeability.

Those in the art have measured measured K_{f} values and the rate of edema formation and calculated the changes in transcapillary pressure that would be required to account for capillary filtration. These calculations indicate that transcapillary pressure gradients of 100-250 mm Hg occurred in the first 10 minutes after a bum. It was then concluded that only a small fraction of the early bum edema could be attributed to changes in permeability, (K_{f}) which suggested that osmotically active molecules were released from cells damaged by burning which were responsible for generating large osmotic resorption pressures.

Studies of capillary pressure, P_{c}, in the scalded hind limb of dogs showed that P_{c} doubled to 45-40 mm Hg in the first 30 minutes after a burn and then slowly returns to the baseline value over a 3-hour period.

Interstitial hydrostatic pressure: P_{if}, Others have demonstrated that the interstitial hydrostatic pressure which is normally—1 mm Hg becomes very negative and reaches—100 mm Hg in isolated skin preparations. Again it is postulated that the very negative values are a result of the denaturation of collagen. The data point to the highly negative values of P_{if} which in conjunction with the increased capillary pressure P_{c}, are the predominant mechanisms responsible for the rapid development of wound edema secondary to a burn.

The plasma proteins normally exert an osmotic effect across the capillary wall trending to maintain the intravascular volume. An osmotic reflection coefficient, O, of 0.1 represents a membrane which is impermeable to protein, while a value of 0 represents a membrane completely permeable to protein. Pitt⁰ measured a 0 of 0.85 for the normal hind paw skin of a dog. This value fell by half or to 0.45 after a scald injury.

Plasma Colloid Osmotic Pressure πₚ

The normal plasma protein concentration of 6-8 g/dl and its associated πₚ of 20-30 -mm Hg produces a significant transcapillary resorptive force limiting fluid filtration out of the microvasculature. Plasma colloid osmotic pressure decreases in non-resuscitated animals as a protein-rich fluid extravasates into the burn wound further reducing the plasma colloid osmotic pressure πₚ in the burn wound. At the same time, a protein-poor fluid is resorbed in nonburned tissues further reducing the plasma colloid osmotic pressure πₚ. The plasma is further diluted and the πₚ is further reduced by resuscitation with large amounts of crystalloid solutions. In resuscitated burned patients, the plasma oncotic pressure is reduced from 20-30 mm Hg to 10-15 mm Hg. The osmotic pressure gradient, πₚ-π_{if}, can actually be reserved in such patients and favors filtration and edema formation.

Interstitial colloid osmotic pressure π_{if} is normally about 10-15 mm Hg, or about one half that of plasma. Direct measurements of π_{if} using wick sampling^{(18,32)} show only modest increases of π_{if} of 1-4 mm Hg in the early non-resuscitated phase after the burn injury.

The cause of the very early increase in extravascular osmotic activity in the damaged tissues is still not fully elucidated. Those have stated that the magnitude of the transcapillary driving force for fluid transfer in the bum in the post-bum period is in the order of 250 to 300 mm Hg, and postulated that this may be due to leakage of intracellular split products into the interstitial space. Still others showed experimentally that thermal degradation of collagen is the main mechanism which is responsible for the generation of increased inbibition pressure. It has been postulated that the bum injury causes partial denaturation of collagen as a result of loss of cross-linking between each element in the triple-helix structure. The subsequent movement of water into this expanded space, and the concentration of the macromolecules in this space result in an increase in the colloid osmotic pressure of the interstitial fluid.

The altered physical factors that have been described above account for the formation of edema in the burn wound. However, after a major burn edema also forms in unburned tissue. Those in the art have reported an increased water content in non-burned skin even after only a 10% burn; reaching its maximum at 12 hours. Still others measured changes in lymph flow and protein transport in non-injured tissues for 12 hours post-bum and found that skin and muscle permeability were elevated for up to 12 hours post-bum for molecules the size of albumin and immunoglobulin G. It is postulated that the sustained increase in water content and the increased lymph flow of these tissues is probably caused by the persistent hypoproteinemia.

The above discussion explains how each of the physical components of the vasculature and the surrounding interstitial tissues contribute to the formation of burn edema. In summary, the sequence leading to edema is as follows.

1. Increased loss from the capillary system because of increase of the capillary filtration coefficient (K_{f}) the loss of albumin into the interstitial tissues.

2. Increase in capillary hydrostatic pressure secondary to vasodilatation and resuscitation fluids.

3. Decreased interstitial fluid hydrostatic pressure allowing fluid to enter the interstitium from the capillaries.

4. And, a decrease in the osmotic reflection coefficient, O, of the capillary wall to half the normal value because of loss of albumin molecules.

5. At the same time the interstitial osmotic pressure π_{if} rises immediately and dramatically because of the osmotic activity exerted by the collagen particles denatured y the bum. The net effect is to create a force of the magnitude of 250 to 300 mm Hg. driving fluid out into the tissues. The edema interferes with the circulation and nutrition of the tissues of the tissues in the “zone of stasis”, where cells are initially viable and often results in necrosis.

Therefore, there is a need in the art for a system and method for facilitating the healing of damaged skin due to frostbite, bums, and/or prolonged periods of abnormal pressure.

Considering the aforementioned theory that the obligatory edema of the skin and deeper adjacent tissues has a deleterious effect on the nutrition and viability of the burned skin, and that it causes the “conversion” from partial to full thickness injury, then by improving circulation to increase arterial inflow and promote venous outflow, the viability of the skin will be preserved.

Therefore, the methods and apparatus of the present invention preserve the viability of the integument of the body when certain portions of the skin are either subjected to injury from extremes of temperature experienced either in bums or frost bite, or from injury that may occur because the blood flow is decreased by an abnormal amount of pressure is exerted over a period of time upon a portion of the skin.

The theory behind the operation of the methods and apparatus of the present invention is that the application of positive and/or negative relative (gage) external pressure to the skin at risk enhances the inflow of blood from the subcutaneous tissues and the dermis to the epidermis or outer layer of the skin, thus enhancing the circulation to the outer layers of the skin which have been injured.

The positive pressure should be applied in a sequential manner, i.e., the positive pressure should begin at the most distal portion of the injured area and then either return to atmospheric or zero pressure, or be subjected to a negative pressure. Following this, the positive pressure should be applied more proximally and so on, up to the most proximal portion of the injured area. The rationale for the sequential nature of the application of the pressure is that it prevents the valving or trapping of venous blood distally which probably would occur if the entire injured area were to be subjected simultaneously to a positive pressure.

Therefore it is an object of the present invention to provide a method and apparatus for facilitating the healing of damaged skin by enhancing blood flow to outer layers of the damaged skin. In addition, the methods and devices of the present invention both prevents and inhibits the formation of edema in the injured tissues.

It is another object of the present invention to provide a system that applies positive and/or negative relative pressure to the desired surface area of the body by creating positive and negative relative air pressure within an enclosed volume over the desired surface of the body.

It is yet another object of the present invention to provide a control means to regulate the generation of the positive and negative relative pressure cycles and preferably synchronize them with the pulses of blood flow to the affected region of the body.

It is yet another object of the present invention to provide means to regulate the temperature of the enclosed volume by means of one or more temperature sensors positioned to sense the said chamber air temperature and to control the heat produced by one or more heating elements that preferably heat either the air entering the chamber or the air already within the chamber.

It is still yet another object of the present invention to provide a means to deliver sterile air to the enclosed volume with controlled humidity and or appropriate medication may also be mixed with the supplied air in the form of a mist or gas or introduced directly into the enclosed volume via appropriately positioned ports in the enclosing shell.

Accordingly, a method for facilitating the healing of damaged skin of a patient is provided. The method comprises: isolating the damaged skin in an enclosure having an air-tight seal between a portion of the enclosure and adjacent skin, the enclosure and skin forming a chamber; and applying cycles of positive and negative pressure in the chamber to enhance blood flow to outer layers of the damaged skin.

The method preferably further comprises: detecting a cardiac cycle of the patient wherein the application of the positive and negative pressure in the chamber are synchronized with the detected cardiac cycle. The synchronizing preferably comprises applying the positive pressure when the cardiac cycle is allowing blood to exit from the damaged skin and the negative pressure is applied when the cardiac cycle is pumping blood into the damaged skin.

Preferably, the applying step comprises pumping a gas into the chamber to apply the positive pressure and withdrawing the gas to apply the negative pressure. The gas is preferably sterile air. The method preferably further comprises heating the gas prior to pumping it into the chamber. More preferably, the temperature inside the chamber is detected; and the heating of the gas is controlled based on the detected temperature.

The method can also preferably further comprise applying a medicine into the chamber. The applying of the medicine preferably comprises introducing the medicine directly into the chamber. Alternatively, the applying of the medicine comprises introducing the medicine into the chamber with the gas.

Preferably, the method further comprises at least partially filling the chamber with an air permeable material and/or covering the damaged skin with a flexible material. The flexible material can alternatively be medicated.

The method also preferably further comprises providing a viewing port on the enclosure and in communication with the chamber to view the damaged skin. The entire enclosure can also be transparent in which case the viewing port comprises the entire enclosure.

Also provided is an apparatus for facilitating the healing of damaged skin of a patient. The apparatus comprising: an enclosure for isolating the damaged skin and for forming a chamber between a wall of the enclosure and the damaged skin, the enclosure having means for sealing a portion thereof to a portion of skin adjacent to the damaged skin; and means for applying cycles of positive and negative pressure in the chamber to enhance blood flow to outer layers of the damage skin.

The apparatus preferably further comprises: a sensor for detecting a cardiac cycle of the patient; and means for synchronizing the application of the positive and negative pressure in the chamber to the detected cardiac cycle.

Preferably, the means for applying cycles of positive and negative pressure in the chamber comprises means for directing pressurized gas into the chamber to apply the positive pressure and means for withdrawing the gas to apply the negative pressure. Preferably, the gas is sterile air. Preferably, the apparatus further comprises a heater for heating the gas prior to pumping it into the chamber. More preferably, the apparatus further comprises: a heat sensor for detecting the temperature inside the chamber; and a controller for controlling the heater based on the detected temperature.

The apparatus preferably further comprises means for applying a medicine into the chamber. Preferably, the means for applying the medicine into the chamber comprises at least one medicine port formed in the wall of the enclosure for introducing the medicine directly into the chamber. Where the means for applying cycles of positive and negative pressure in the chamber comprises means for pumping a gas into the chamber to apply the positive pressure and means for withdrawing the gas to apply the negative pressure, the means for applying the medicine into the chamber preferably comprises a means for introducing the medicine into tubing used to carry the gas into the chamber.

The apparatus also preferably further comprises an air permeable material for at least partially filling the chamber and/or a flexible material for covering the damaged skin. Preferably, the flexible material further comprises a medicine disposed thereon.

Preferably, the apparatus further comprises one or more viewing ports formed on the wall of on the enclosure and in communication with the chamber to view the damaged skin.

The enclosure of the apparatus preferably has at least two segments formed in the wall and joined by a hinge for forming the enclosure to the shape of the body adjacent to the damaged skin. The hinge is preferably a living hinge. The at least two segments preferably comprise a plurality of segments formed in a first direction, each segment being joined to an adjacent segment by the hinge. More preferably, the at least two segments comprise a plurality of segments formed in both first and second directions, each segment being joined to an adjacent segment by the hinge.

Still yet provided is an enclosure for covering a body portion. The enclosure comprises: a wall having a portion thereof for providing a seal between the enclosure and the body portion for isolating the body portion in a chamber formed between the body portion and the wall; and at least two segments formed in the wall and joined by a hinge for forming the enclosure to the shape of the body portion. The hinge is preferably a living hinge. The at least two segments preferably comprise a plurality of segments formed in a first direction, each segment being joined to an adjacent segment by the hinge. More preferably, the at least two segments comprise a plurality of segments formed in both first and second directions, each segment being joined to an adjacent segment by the hinge.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates the apparatus of the present invention, shown having an enclosure isolating the chest of a patient.

FIG. 2 illustrates a schematic of a preferred implementation of the apparatus of FIG. 1.

FIG. 3 illustrates sectional view of the enclosure of the apparatus of FIG. 1, shown on a body portion.

FIG. 4 illustrates an alternative configuration of the enclosure of the apparatus of FIG. 1.

FIG. 5 illustrates a sectional view of the enclosure of FIG. 4 as taken along line 5-5 of FIG. 4.

FIG. 6 illustrates a yet another alternative configuration of the enclosure of the apparatus of FIG. 1.

FIG. 7 illustrates still yet another alternative configuration of the enclosure of the apparatus of FIG. 1.

FIG. 8 illustrates a preferred configuration for securing the enclosure of FIG. 7 to the body of the patient.

FIG. 9 illustrates a plan view of an enclosure wall having segments and hinges formed therein in a first direction.

FIG. 10 illustrates a sectional view of the enclosure of FIG. 9 as taken along line 9-9 in FIG. 9.

FIG. 11 illustrates an alternative configuration of the enclosure of FIG. 9, wherein the segments and hinges are formed in first and second directions.

FIG. 12 illustrates a schematic diagram of a preferred valve unit of FIG. 2.

### DETAILED DESCRIPTION OF THE PREFERRED EMBODIMENT

Although this invention is applicable to numerous and various types of skin injuries, it has been found particularly useful in the environment of burns, frostbite, and injuries due to prolonged periods of abnormal pressure. Therefore, without limiting the applicability of the invention to burns, frostbite, and injuries due to prolonged periods of abnormal pressure, the invention will be described in such environment.

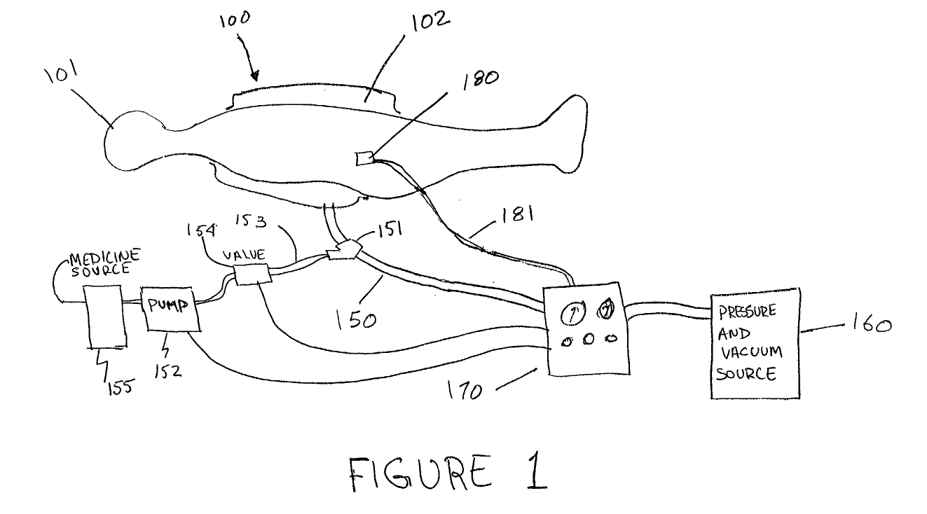

Referring now to FIG. 1, a general schematic of a preferred implementation of an apparatus of the present invention is shown therein and generally referred to by reference numeral 50. Apparatus 50 consists of an enclosure 100 that seals a segment of the body 101 to form an enclosed chamber 102. A tubing system 150 preferably consists of one or more tubes to provide an inflow of gas into the enclosed chamber 102, preferably at a high relative (gage) pressure and to also provide for an outflow of gas from the enclosed chamber 102 to generate a relative (gage) negative pressure within the enclosed chamber 102. A means 160 for generating the required relative vacuum and pressurized gas is also provided as is a control unit 170. The control unit 170 has a valve system and preferably electronic control system, which is preferably equipped with a microcomputer to regulate the supply of pressurized air and vacuum to the enclosed chamber 102. One or more sensors 180 are provided to sense the blood flow pulses and send appropriate signals through the one or more signal lines 181 to the control unit 170 to preferably synchronize the pressurization and vacuum generation cycles within the enclosed chamber 102 with the pulses of the blood flow. Preferably, the synchronization is achieved by detecting the pulse near the injured area since there is a delay between the cardiac and local pressure pulses. In the schematic of FIG. 1 and for the sake of simplicity, only one enclosing means 100 which is supplied by only one tubing system 150 are shown. It is however, understood that more than one enclosing means 100 may be applied to more than one segment of the patient body and that each enclosed chamber 102 may be supplied with more than one tubing system 150, means for generating the and vacuum and pressurized gas 160, and control unit 170.

In the present descriptions, air is considered to be the medium that is injected into the enclosed volume to generate the desired internal pressure. It should however be appreciated that any appropriate gas or fluid may also be similarly used. However, sterile air with a controlled amount of humidity and temperature is preferred in most situations. It may also be desirable to add an appropriate amount of medicating substances such as antimicrobial oils or similar liquids, preferably in the form of a gaseous substance or fluid mist, to the inflow stream. Preferably, the medicine is added to the inflow stream of gas at a port 151, for example by a pump 152. A tubing line 153 connecting the outlet of the pump 152 to the port 151 preferably has a valve 154 which closes when the apparatus is in the vacuum cycle and opens when medicine is to be added to the inflow stream of gas. The pump 152 is preferably connected at its inlet to a medicine supply 155. Both the pump 152 and valve 154 are connected to the control unit 170, which synchronizes them to deliver medicine to the inflow stream of gas when needed and to prevent the flow of medicine when the vacuum cycle is applied. Alternatively, medicine can be manually injected into the port 151 or directly into the enclosure by any means known in the art, such as by a syringe (not shown).

Alternatively, a balloon (not shown) can be utilized in the enclosure 100 which is selectively inflated with a fluid to minimize the volume of the enclosed chamber 102. In this way, an enclosure can be used on various size limbs or other body parts without the need for customization according the particular shape or size of the patients injured area. For instance, an enclosure 100 for a patients arm can be made relatively large to fit the largest of a person's arm and the same enclosure can be used on patients having smaller arms by inflating the balloon inside the enclosed chamber 102 to minimize the volume of the enclosed chamber 102.

The pressurization and vacuum cycles are preferably synchronized with the cardiac systole and diastole so that as the blood is being pumped into the burned region, a vacuum is generated within the enclosed chamber 102 to assist in the inflow of the blood and the enclosed chamber 102 is pressurized to assist the flow of the blood out of the burned region. The synchronization may be with each cardiac cycle, or with a cardiac cycle after skipping one or more number of cycles. However, the apparatus may be operated without this synchronization, in which case the sensor 180 component of the apparatus is not required. The sensor to detect the patient's pulse 180 is preferably one of the commonly used sensors in medial practice, such as an EKG or pressure sensor that senses the pulse at the location of the sensor. A sensor signal is sent from the sensor 180 to the control unit 170 that processes the signal to synchronize the relative vacuum generation and pressurization cycles by properly operating the control unit valves and the means of introducing various treatment substances into the enclosed chamber 102. Preferably, the negative pressure is applied as the blood is being pumped in and the positive pressure is applied as the blood is pumped out of the injured region.

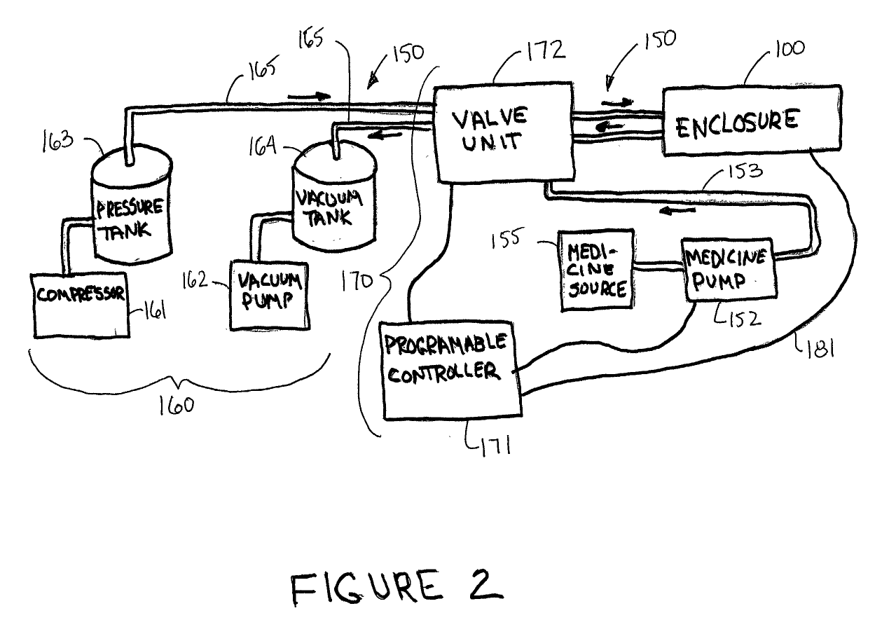

Referring now to FIG. 2, an example of a configuration of the means 160 for generating the required relative vacuum and pressurized gas, the control unit 170, and the tubing system are shown in more detail. The pressurized air is preferably supplied by an air compressor 161. In certain cases, the amount of pressure that is required may be within the range of fan or turbo or other similar types of air flow generation devices that may then be utilized. The vacuum is also preferably provided using a vacuum pump 162. Each of the air compressor 161 and vacuum pump 162 are connected to a respective tank 163, 164 by appropriate plumbing 165. The air compressor tank 163 must be fabricated to withstand high pressure, while the vacuum tank 164 must be fabricated to withstand a high vacuum. The plumbing 165 connects each tank 163, 164 to the valving of the control unit 170. However, when the amount of pressurized air to be delivered to the enclosed chamber 102 is relatively small, the required air may be delivered from essentially closed one or more chambers which are preferably sealed and are constructed with one or more flexible walls and are used to pump their enclosed air in and out of the enclosed chambers 102. Such “pumps” are preferably constructed with bellows and are operated with electrically driven actuation means. However, other constructions of such enclosures with one or more flexible walls may be utilized and be driven by electric, pneumatic or other actuation means. In general, by pumping an appropriate amount of air from the enclosed chamber 102 using the above essentially closed circuit pumping systems, the required level of vacuum may also be generated within the enclosed chamber 102. In general, wherever the volume of the enclosed chamber 102 is small enough to allow the use of the above air pressure and vacuum generation system, the use of such systems are preferred over conventional compressors and vacuum pumps.

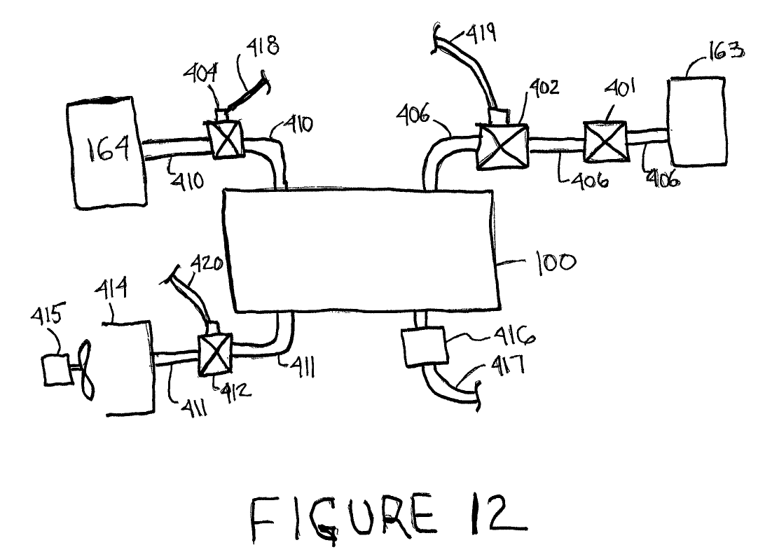

The control unit 170 preferably comprises a programmable controller 171, such as a PC, and a valve unit 172. The programmable controller is programmable to operate the desired operation sequence and timing of the air compressor, 161, vacuum pump, medicine pump 152, and assorted valves. In FIG. 2, valve 154 is not shown because it is preferably incorporated into the valve unit 172. Referring now to FIG. 12, there is shown a preferred implementation of the valve unit 172. The valve unit 172 is preferably constructed and operates as follows. One or more solenoid valves 402 controls the flow of pressurized air into the enclosure 100 from the tank 163 through a pressure regulator 401 via piping 406. The operator of the solenoid of the valve 402 is achieved by the signal from the programmable controller 171. The outflow of the air from the enclosure 100 into the vacuum tank is controlled by one or more open-closed solenoid valves 404. The air is exhausted into the vacuum tank 164 via piping 410. More than one pressurized air inlets 406 and valves 402 may be used along the length of the enclosure 100 to achieve the sequential pressurization of the enclosure as previously described. In a similar manner, more than one vacuum outlet may be used to provide for the sequential negative pressure application to the injured area as previously described. When the free volume within the enclosure 100 is relatively large, the outflow of air may be accelerated and the capacity of the vacuum pump 162 and the vacuum tank 164 may be significantly reduced by providing an exhaust outlet operated by an exhaust fan 415 and one or more relatively large diameter solenoid valves, with the piping 411.

When utilized, the valves 412 are turned on first and when a considerable amount of the required air is exhausted, the valve 412 is closed and the valve 404 is then opened. One or more pressure sensors 416 are used to measure the pressure within the enclosure 100 and send the measurement by line 417 to the programmable controller 171. The solenoid valves 402, 404, and 412 are operated by signals sent by the programmable controller via lines 419, 418, and 420, respectively.

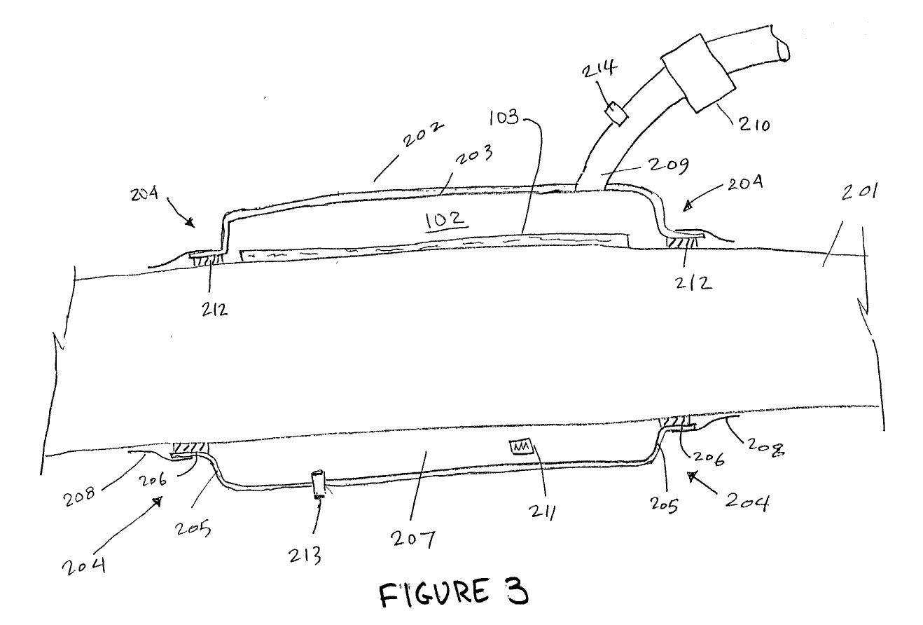

A first variation of the enclosure 100 is shown in the schematic of FIG. 3. In FIG. 3, a segment of the body, e.g., a segment of the leg or the arm or the trunk 201, is shown enclosed within a relatively rigid outer shell 202. The outer shell 202 must be rigid so as not to deform under the pressurization or vacuum within the chamber 102. The outer shell 202 is constructed with an outer wall 203 and sides 204. The sides 204 have walls 205 to keep the outer wall 203 at a certain distance from the body segment surface (skin) and provide the enclosed volume 207 of the chamber 102. Lips 206 projecting from the walls 205 are also provided on the sides 204 to provide a relatively large surface area for contact with the body surface (skin) to distribute the contact forces over a large enough surface area during the operation of the apparatus 50. The sides 204 and the outer wall 203 are preferably integrally formed.

The lips 206 of the sides 204 are preferably sealed to the surface of the body segment to provide the sealed volume 207. A layer of a relatively soft sealing material 212, such as soft rubber, may be placed between the lips 206 and the body surface to conform to the body surface, to assist the sealing action, and to distribute the load more evenly over the body surface. The layer 212 and the sides 204 may also be integral. Medical adhesive tape 208 is preferably used to secure the enclosure 100 to the patient, if necessary.

The outer shell 202 may be constructed as one piece or may be made out of one or more segments that are attached and sealed together during the assembly. The outer wall 203 and/or the sidewalls 205 are provided with one or more openings with ports 209 to allow gas inflow and outflow from tubing system 150. In the preferred embodiment, gas flows in from one or more ports while the air flows out from one or more other ports that are situated away from the inflow ports. One or more heating unit 210 may be provided in one or more inflow air streams and one or more temperature sensors 211 may be provided to measure the temperature within the enclosed volume 207 for the purpose of regulating the temperature of the air within the enclosed volume 207 and to keep the enclosed volume 207 close to a set temperature. The temperature sensor 211 preferably generates a signal indicative of the temperature within the chamber 102 and outputs the signal to the heating unit 210 either directly if the heating unit 210 has a processing capability or through the programmable controller 171, which assumes control of the heating unit 210.

Appropriate medication may be mixed with the inflow air through one or more ports 151 located on or near one or more air inlets 209 as described above, or may be introduced directly into the enclosed chamber through one or more sealed ports 213.

The surface (skin) of the segment of the body 201 located within the enclosure 100 maybe covered by a soft and flexible material 103 such as fabric, sponge, or silicon rubber or the like by specially constructed and possibly medicated material. The enclosed volume 207 may be partially or fully filled with an air permeable sponge type of material 104 (shown in FIG. 5) or the like to provide support for the outer wall 203, and/or reduce the amount of required air inflow and outflow to produce the desired positive and negative relative pressure within the enclosed volume 207 to support the surface of the body. The air permeable material can also be spherical or other shaped pellets, as are known in the art.

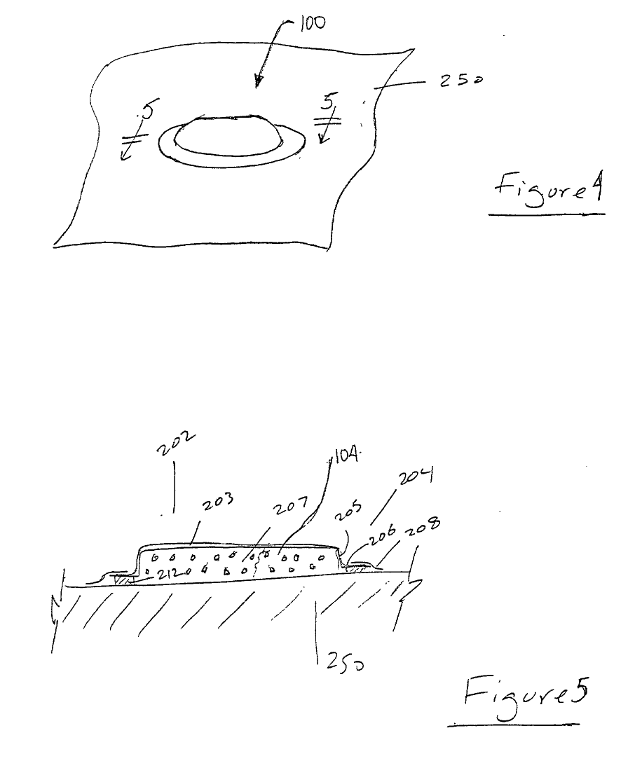

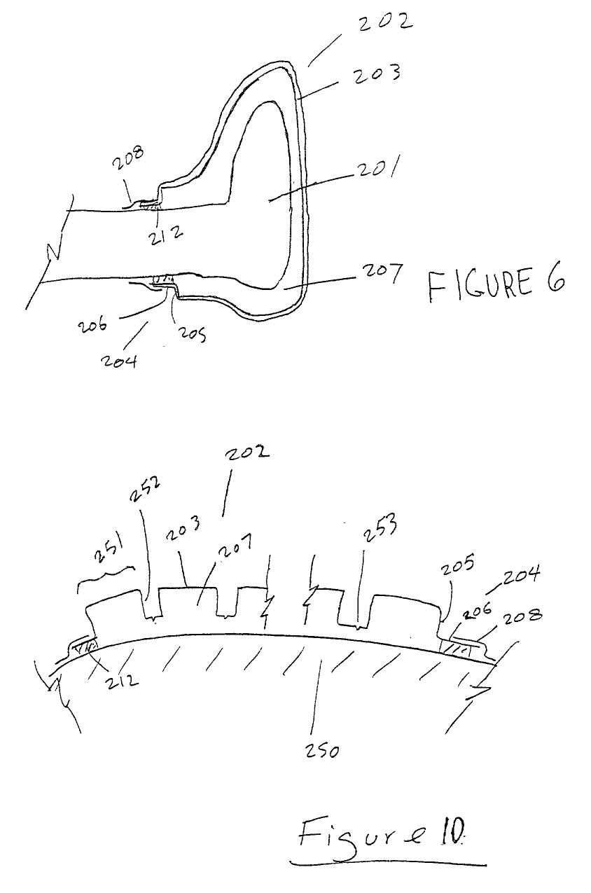

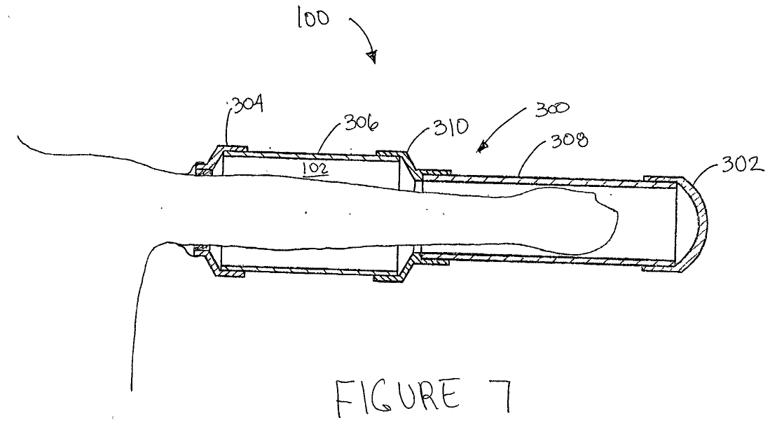

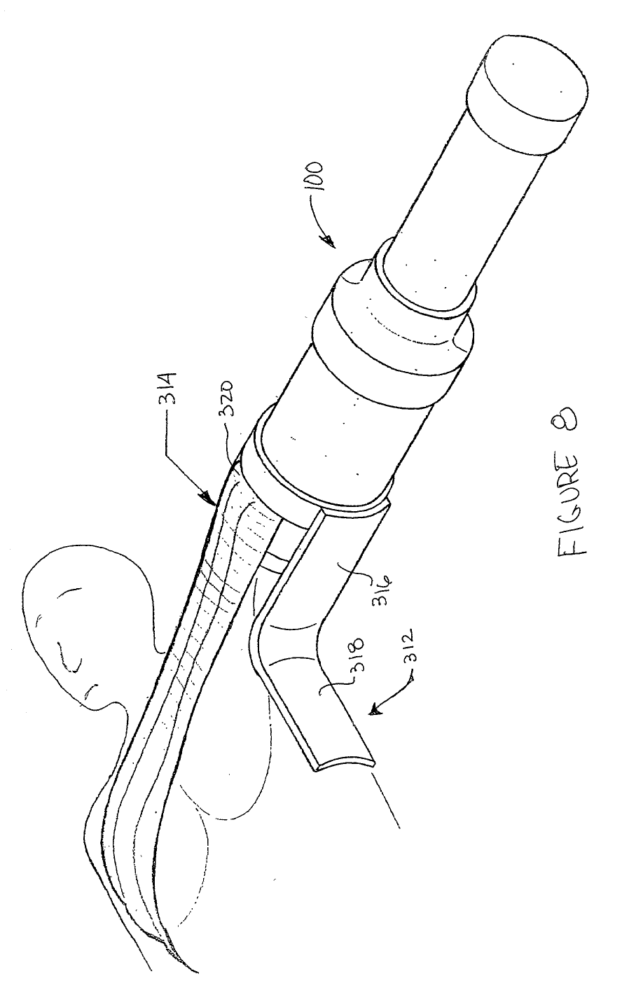

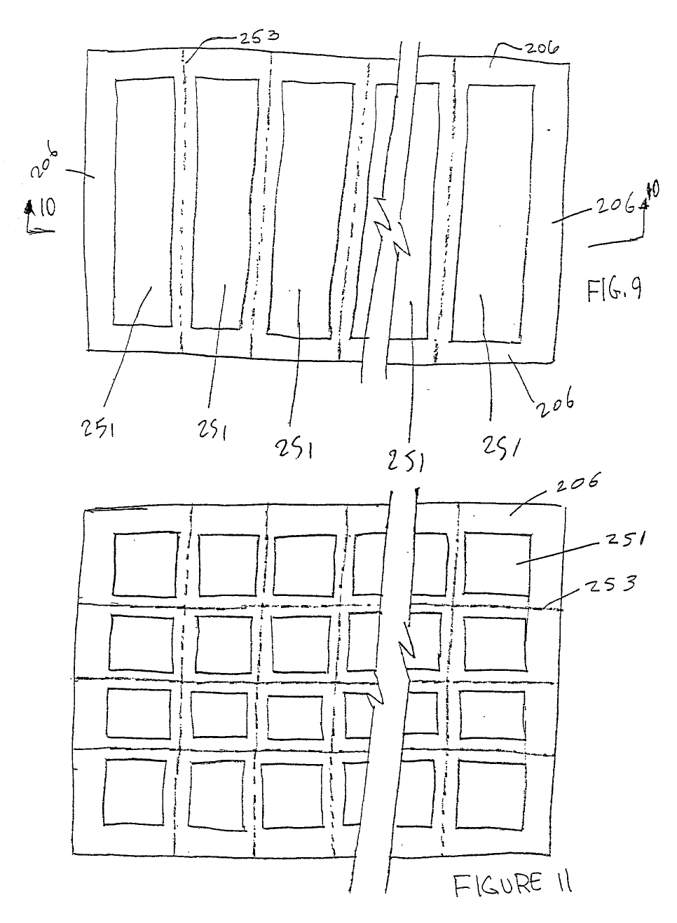

The shell 202 of the enclosure may be constructed in a tubular shape to go around a segment of the body such as arm, leg, thigh or the trunk as shown in FIG. 3. The shell 202 of the enclosure 100 may also be used to cover a certain area of the surface of the body 250 as shown schematically in FIG. 4, the cross-section 5-5 of which is shown in FIG. 5. In FIGS. 3 and 5, like elements are indicated by like reference numbers and perform in a like manner. The enclosure 100 of FIG. 4 functions as described for the enclosure of FIG. 3. In FIGS. 4 and 5, the peripheral elements 209-211 and 213-214 are not shown for the sake of simplicity but are understood to be included and function as previously described. The enclosure 100 may also be used on an extremity such as a foot, in which case it is preferably constructed with one opening with side structure 204 as shown in cross-sectional schematic of FIG. 6. In the schematic of FIG. 6, for the sake of simplicity, only a small number of components of the enclosure are shown. But it is understood that all the components shown in FIG. 3 are also present and utilized in the same manner in this variation of the enclosure 100 design.

When the surface area of the outer wall of the enclosure shell 203 is small or has a shape that renders it relatively stiff to deformation into the enclosed volume 207 (FIG. 4), when the negative relative pressure is applied to the enclosed volume and when it is also relatively stiff and resists outward deformation when the positive relative pressure is applied to the enclosed volume 207, then a simple plate with an appropriate thickness that is cut and formed to the required shape would be sufficient to form the outer surface 203 of the enclosure 202 and is also preferred. The outer wall 203 is preferably constructed with easily deformed and sterilized plate material such as Plexiglas or other relatively hard plastics or metals such as stainless steel. A clear plastic port 105 for easy viewing of the covered surface is, however, preferred for at least a portion of the outer wall 203 surface to provide for a viewing window.

Referring now to FIG. 7, there is shown another version of the enclosure 100. The enclosure of FIG. 7 is particularly well-adapted to appendages such as the arm or leg and is shown therein for use with the arm. The enclosure 100 of FIG. 7 is constructed of a body 300, a closed end fitting 302, and preferably an open end fitting 304. The body 300 preferably comprises at least one tubular rigid section. In the preferred implementation shown for adapting to an arm of a patient, two such rigid tubular sections 306, 308 are shown. The sections 306, 308 are preferably joined by a coupling 310. The rigid sections 306, 308, closed end fitting 302, open end fitting 304, and coupling 310 are joined so as to provide an appropriately sealed chamber 102. In this configuration, the rigid sections 306, 308 can be appropriately sized to provide more or less volume as needed in a particular area of the appendage. In FIG. 7, for the sake of simplicity, only a small number of components of the enclosure are shown. Bit it is understood that all of the components shown in FIG. 3 are also present and utilized in the same manner in this variation of the enclosure 100 design.

Referring now to FIG. 8, there is shown the enclosure 100 of FIG. 7 having a means for supporting the enclosure 100 on the patient. Since the enclosure is pressurized at some points during treatment, and since the enclosure 100 of FIG. 7 is closed as one end, it may have a tendency to fly off of the patient during the pressurization cycle. Furthermore, the enclosure may tend to move upwards towards the armpit of the patient during the vacuum cycle. Therefore, it is important that the enclosure 100 be properly supported and secured to the patient. Preferably, this support is provided by a support bracket 312 and support strap 314. The support bracket 312 is preferably fabricated from a rigid material and having an “L” shape. A first leg 316 of the “L” shape is fastened to the enclosure 100 and a second leg 318 of the “L” shape rests against an adjacent side of the patient. The first leg 316 may be adjustably connected to the enclosure 100 to vary the distance between the enclosure 100 and the side of the patient. The support strap is preferably fabricated from a flexible material that wraps around the torso of the patient and is attached to the enclosure at both ends 320 (one of which is shown). The support strap 314 also preferably has an adjustment means, such as a belt buckle (not shown) to vary its length.

Referring now to FIGS. 9-11, another variation of the enclosure of the present invention is shown. In this variation, the outer wall of the enclosure shell 203 is constructed with variously shaped bubbles 251 that are hinged together, preferably with living hinges 253, to allow them to conform to the shape of the body, leaving a relatively small space between the outer walls of the enclosure and the body surface. The cross-section of such an enclosure 202 is shown schematically in FIG. 10. The bubbles 251 with sides 252 and living hinges 253 may extend in a first direction to cover the entire length of the enclosure or a portion thereof. The top view of a first variation of the bubble configuration is shown in FIG. 9. This construction is preferred for covering limbs such as legs or arm. The bubbles 251 may extend in a second direction along the length of the enclosure as shown in FIG. 11. The second variation of the bubble configuration shown in FIG. 11 is preferred for covering surfaces such as the back or chest so that the enclosure can conform more closely to the body surface. The bubbles also function as stiffeners to limit the inward and outward deformation of the outer surfaces of the enclosure during the application of relative vacuum and pressures, respectively. In addition, the shape of the bubbles are shown to be nearly square and/or rectangular and having orthogonal tops and sides. In practice, however, the bubbles may be provided in any shape and their side 252 or top surfaces may be tapered to allow better conformation to the commonly tapered limbs of the body.

Method of Treatment: The following method of treatment is given by way of example only and not to limit the spirit or scope of the present invention in any way.

The device which will apply external synchronous pulsatile pressure to either the whole body or portions of the body has as its goal the preservation of injured areas of tissues of the body, particularly in the zone of stasis. This will be accomplished by controlling the edema, which begins to form in the tissues immediately after the burn.

The pulsatile external pressure will vary from −25 mm Hg., +300 mm Hg. and will be applied synchronous with the cardiac cycle. The positive phase will be applied during cardiac diastole and the negative phase during cardiac systole. The positive phase will enhance venous drainage from the wound, and the negative phase will enhance arterial inflow into the subdermal plexus.

The dermis is divided into a thin, superficial layer called the papillary dermis and a deeper layer called the reticular dermis. There is a large plexus of vessels beneath the dermis, known as the subdermal plexus, which sends vessels towards the periphery to form a plexus between the reticular and papillary dermis. More superficially there is a plexus of vessels called the papillary plexus. The blood supply to all of these small vessels becomes occluded as a result of the edema caused by the factors that were described earlier in this document; and is further aggravated by the infusion of large amounts of crystalloid solution which quickly extravasates into the interstitial tissues and augments the volume of edema.

The pulsatile pressure system will be applied as soon after the burn occurs as is possible, and will preferably be applied for up to 4 days, the period during which edema normally continues to form and finally is stabilized. The pulsatile pressures will be applied continuously, and interrupted as frequently as is necessary to inspect and treat the wound surface, i.e. 2-3 times daily.

Ancillary Measures:

Those in the art have showed that capillary stasis can be reversed by careful maintenance of hydration of the wound surface, and by avoiding over or under hydration during the resuscitation phase after the burn.

Since the internal setting for thermal control of the body is set at a higher level in burned patients there is a significant evaporative water loss after 24 hours which allows the body to lose heat, the heat setting external to the body will be kept at a sufficiently high level to prevent shivering and to maintain a normal body temperature.

The wound surface will be washed several times a day with soap and will be treated with topical antimicrobial agents, and with either a plastic film such as “Biobrane” or cultured alografts, in order to prevent desiccation of the skin surface.

Systemically, heparin will be administered in a doses sufficient to provide prophylaxis against thrombus formation. The resuscitation regimen will be primarily with Lactated Ringer's solution—given in a dose of 4 cc/Kg body wt % burn; or as 3 cc/Kg % Lactated Ringer's with plasma in a dose of 1 cc/Kg % burn.

Systemic antibiotics will be withheld during this period unless there is a specific indication.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for facilitating the healing of damaged skin of a patient, the method comprising:
isolating the damaged skin in an enclosure having an air-tight seal between a portion of the enclosure and adjacent skin, the enclosure and skin forming a chamber; and
applying cycles of positive and negative pressure in the chamber to enhance blood flow to outer layers of the damaged skin and inhibit the formation of edema in the damaged skin.

2. The method of claim 1, further comprising:
detecting a cardiac cycle of the patient; and
wherein the applying comprises synchronizing the application of the positive and negative pressure in the chamber to the detected cardiac cycle.

3. The method of claim 2, wherein the synchronizing comprises applying the positive pressure when the cardiac cycle is allowing blood to exit from the damaged skin and the negative pressure is applied when the cardiac cycle is pumping blood into the damaged skin.

4. The method of claim 1, wherein the applying step comprises pumping a gas into the chamber to apply the positive pressure and withdrawing the gas to apply the negative pressure.

5. The method of claim 4, wherein the gas is sterile air.

6. The method of claim 4, further comprising heating the gas prior to pumping it into the chamber.

7. The method of claim 6, further comprising:
detecting the temperature inside the chamber; and
controlling the heating of the gas based on the detected temperature.

8. The method of claim 1, further comprising applying a medicine into the chamber.

9. The method of claim 8, wherein the applying of the medicine comprises introducing the medicine directly into the chamber.

10. The method of claim 5, further comprising applying a medicine into the chamber, wherein the applying of the medicine comprises introducing the medicine into the chamber with the gas.

11. The method of claim 1, further comprising at least partially filling the chamber with an air permeable material.

12. The method of claim 1, further comprising covering the damaged skin with a flexible material.

13. The method of claim 12, further comprising medicating the flexible material.

14. The method of claim 1, further comprising providing a viewing port on at least a portion of the enclosure and in communication with the chamber to view the damaged skin.

15. An apparatus for facilitating the healing of damaged skin of a patient, the apparatus comprising:
an enclosure for isolating the damaged skin and for forming a chamber between a wall of the enclosure and the damaged skin, the enclosure having means for sealing a portion thereof to a portion of skin adjacent to the damaged skin; and
means for applying cycles of positive and negative pressure in the chamber to enhance blood flow to outer layers of the damaged skin and inhibit the formation of edema in the damaged skin.

16. The apparatus of claim 15, further comprising:
a sensor for detecting a cardiac cycle of the patient; and
means for synchronizing the application of the positive and negative pressure in the chamber to the detected cardiac cycle.

17. The apparatus of claim 15, wherein the means for applying cycles of positive and negative pressure in the chamber comprises means for directing pressurized gas into the chamber to apply the positive pressure and means for withdrawing the gas to apply the negative pressure.

18. The apparatus of claim 17, wherein the gas is sterile air.

19. The apparatus of claim 17, further comprising a heater for heating the gas prior to directing it into the chamber.

20. The apparatus of claim 19, further comprising:
a heat sensor for detecting the temperature inside the chamber; and
a controller for controlling the heater based on the detected temperature.

21. The apparatus of claim 15, further comprising means for applying a medicine into the chamber.

22. The apparatus of claim 21, wherein the means for applying the medicine into the chamber comprises at least one medicine port formed in the wall of the enclosure for introducing the medicine directly into the chamber.

23. The apparatus of claim 21, where in the means for applying cycles of positive and negative pressure in the chamber comprises means for directing pressurized gas into the chamber to apply the positive pressure and means for withdrawing the gas to apply the negative pressure and wherein the means for applying the medicine into the chamber comprises a means for introducing the medicine into tubing used to carry the gas into the chamber.

24. The apparatus of claim 15, further comprising an air permeable material for at least partially filling the chamber.

25. The apparatus of claim 15, further comprising a flexible material for covering the damaged skin.

26. The apparatus of claim 25, wherein the flexible material further comprises a medicine disposed thereon.

27. The apparatus of claim 15, further comprising a viewing port formed on at least a portion of the wall of on the enclosure and in communication with the chamber to view the damaged skin.

28. The apparatus of claim 15, wherein the enclosure having at least two segments formed in the wall and joined by a hinge for forming the enclosure to the shape of the body adjacent to the damaged skin.

29. The apparatus of claim 28, wherein the hinge is a living hinge.

30. The apparatus of claim 28, wherein the at least two segments comprise a plurality of segments formed in a first direction, each segment being joined to an adjacent segment by the hinge.

31. The apparatus of claim 28, wherein the at least two segments comprise a plurality of segments formed in both first and second directions, each segment being joined to an adjacent segment by the hinge.

32. An enclosure for covering a body portion, the enclosure comprising:
a wall having a portion thereof for providing a seal between the enclosure and the body portion for isolating the body portion in a chamber formed between the body portion and the wall; and
at least two segments formed in the wall and joined by a hinge for forming the enclosure to the shape of the body portion.

33. The enclosure of claim 32, wherein the hinge is a living hinge.

34. The enclosure of claim 32, wherein the at least two segments comprise a plurality of segments formed in a first direction, each segment being joined to an adjacent segment by the hinge.

35. The enclosure of claim 32, wherein the at least two segments comprise a plurality of segments formed in both first and second directions, each segment being joined to an adjacent segment by the hinge.

36. A method for facilitating the healing of damaged skin of a patient, the method comprising:
isolating the damaged skin in an enclosure having an air-tight seal between a portion of the enclosure and adjacent skin, the enclosure and skin forming a chamber; and
applying at least one of positive and negative pressure in the chamber to enhance blood flow to outer layers of the damaged skin.
